(19) United States
(12) Patent Application Publication
(10) Pub. No.: US 2002/0059082 A1
(43) Pub. Date: May 16, 2002

(54) Appointment setting and payment system and method

(76) Inventor: Roger Moczygemba, San Antonio, TX (US)

Correspondence Address: Cline H. White, JACKSON WALKER L.L.P., Suite 2100, 112 E. Pecan Street, San Antonio, TX, 78205, US

(21) Appl. No.: 10/003,361

(22) Filed: Nov. 15, 2001

Related U.S. Application Data
(60) Provisional application No. 60/249,045, filed on Nov. 15, 2000.

(51) Int. Cl. G06F 17/60

(52) U.S. Cl. 705/3

(57) ABSTRACT

A method and healthcare streamlining system comprising the steps of a healthcare provider uploading an appointment schedule onto a global network communications system; and a patient accessing the appointment schedule over the global network communications system, selecting an available time on the appointment schedule for an appointment, inputting patient information and securing the appointment by verifying a patient's insurance or with an electronic payment. The patient then enters the healthcare provider's office on the scheduled day and the healthcare provider renders medical services to the patient. The patient then leaves the healthcare provider's office and may schedule a follow-up visit if necessary.

An alternative method and healthcare streamlining system is provided for patients who are traveling abroad where the patient may access a healthcare provider in a particular area. The alternative method includes the steps of: a healthcare provider uploading an appointment schedule onto a global network communications system; and a patient accessing the appointment schedule over the global network communications system; and a patient accessing the appointment schedule over the global network system by inputting healthcare provider-related information. The patient then selects an available time on the healthcare provider's appointment schedule, inputs patient information and secure the appointment through a preauthorized insurance verification procedure or with an electronic payment.

### BACKGROUND OF THE INVENTION

1. Field of the Invention

Applicants' invention relates to a method and system for providing healthcare services; more particularly, the invention provides for a method and system for streamlining a business process utilized in patient appointment docketing.

2. Background Information

Traditionally, when a patient schedules an appointment with a healthcare provider, for example a physician, the patent normally telephones the healthcare provider's office where a staff member negotiates with the patent a day, time and healthcare provider to be seen and records the information onto a particular healthcare provider's schedule. Frequently, and usually unknown to a patient, the healthcare provider's schedule is double-booked. As a result, at least one patient must normally wait in the healthcare provider's waiting room for a period of time. Many waiting periods can become quite extensive; and the idle time spent by a patient who is in a queue to be seen by a healthcare provider may often cause a backlog for subsequently booked appointments.

Moreover, many times while a patient waits, he/she may come to learn that either his/her insurance coverage is not accepted by the healthcare provider or the healthcare provider does not belong to a particular healthcare plan (e.g., a Health Maintenance Organization). As a result, if the patient does not have any other means of payment, he/she will have unsuccessfully spent his/her time in the waiting room without ever seeing the healthcare provider.

Further, many healthcare providers may suddenly rearrange their schedules according to a particular patient's symptoms. This scheduling system is called a triage (also known as prioritizing). Triage is the system of prioritizing patients on the basis of the severity of their conditions. Thus, a more severely injured or sick person will be considered a high priority patient and may be quickly seen by a healthcare provider relative to other lower priority patients, who must continue to wait lengthy periods of time.

Consequently, many patients, especially patients with minor health problems, forego visiting a healthcare provider just to avoid spending time on paperwork associated with finances and healthcare insurance coverage and also avoid lengthy waiting periods. In turn, many healthcare providers become frustrated because even a patient's minor health problems may progress to a more serious illness and each healthcare provider wants to prevent development of serious complications.

Aside from the patients' frustrations, healthcare providers have had to increasingly raise their overhead for staff to deal with coding, billing and collections for the healthcare provider's medical practice, especially when accepting a patient who has medical insurance, in order for the practice to financially survive. Thus, as staff spends an inefficient amount of time on collections, revenue decreases thereby complicating a portion of a healthcare provider's practice.

Currently, many businesses have incorporated a computer system to help streamline their daily operations. An example of such a system is shown in U.S. Pat. No. 6,035,278 to Mansour issued on Mar. 7, 2000, describing a Method and System for Schedule and Task Management. Specifically, the '278 patent provides for a scheduling system adapted for use with computer systems where a schedule owner schedules tasks and appointments with a scheduling tool. A scheduler accesses the schedule owner's appointment agenda utilizing the scheduling tool to search for unscheduled times in which to set a meeting. However, the '278 system does not provide for a patient's medical history, current symptom information and current medications utilized.

Another example of a scheduling system is depicted in U.S. Pat. No. 6,112,182 to Akers, et al. issued on Aug. 29, 2000. The '182 patent provides for a method and apparatus for integrated management of pharmaceutical and healthcare services. The method described in the '182 patent includes scheduling an appointment for monitoring lifestyle, health or disease states or conditions and printing information on a dispensed drug. However, the '182 patent fails to provide for a method and system where a patient may schedule an appointment for a designated amount of time and secure the appointment with an electronic payment.

Moreover, due to technological advancements, many patients are turning to the Internet for medical information services. An example of a present Internet website that provides medical information services is WebMD.com. This website uses the Internet to serve the healthcare industry from consumers to medical professionals. For consumers, WebMD features healthcare information, breaking health news and solicits questions from the consumer during live chat events. For medical professionals, WebMD integrates extensive news, reference and research material; immediate online insurance eligibility verification and referrals; extensive online Continuing Medical Education; lab tests; clinical reports; and customized website services. However, WebMD fails to provide a method for practicing medicine where healthcare providers want to streamline their practice by increasing their cash flow and minimizing time spent on collections by their staff. Also, WebMD does not provide a service which allows a patient to set and secure an appointment with a healthcare provider over a network communications system, such as the Internet.

In view of the above described deficiencies associated with the use of conventional office management systems and methods, the present invention has been developed to alleviate these drawbacks and provide further benefits to the user. These enhancements and benefits are described in greater detail herein below with respect to several alternative embodiments of the present invention.

### SUMMARY OF THE INVENTION

Traditionally, healthcare practices manage their appointment scheduling by having a patient call the healthcare provider's office and request an appointment for a particular day and time. The patient then comes into the healthcare provider's office on the scheduled day and waits in the waiting room until he/she is called to see the healthcare provider. During the wait, financial information and/or payment is normally exchanged or negotiated between the patient and the healthcare provider's staff. Once the patient goes into the examining room, vitals are taken and the healthcare provider asks a series of medical-related questions and performs a physical exam in order to determine a diagnosis.

The present invention provides a novel method that is intended to be implemented over the Internet, or other computer, electronic, or communications network. It finds specific industrial applicability in network communications and healthcare industries. It provides a streamlined appointment scheduling and payment system for healthcare providers and their patients. Using the present invention, the healthcare providers can set their availability for appointments, and the patients can set their own appointment, within the timeframe set by the healthcare provider. Additionally, the present invention allows the patient to electronically prepay for the appointment, and to electronically make arrangements for insurance coverage.

The present invention further provides:

a. appointment management over the Internet, or other computer, electronic, or communications network;

b. prepayment assures healthcare provider of payment;

c. accessibility to static records;

d. patient can pick appointment time period;

e. patient's waiting period is reduced;

f. history of present illness or condition, and chief complaint are filled out for healthcare provider prior to appointment, and are thus ready for review;

g. reduced staffing and staff work; and

h. allows patient to set appointments with multiple healthcare providers in multiple locations.

While the present invention is not intended to be exclusively controlled by computer programs or algorithms on the Internet, it is intended that the present invention can be mostly implemented and controlled by computer programs or algorithms over the Internet, or other computer, electronic, or communications network. Therefore, the present invention contemplates a series of computer algorithms and method by which the present invention is implemented and controlled. Thus, in some of the descriptions herein, the present invention is presented partly in terms of process steps and operations of data bits within a computer memory. An algorithm is here, and generally, conceived to be a self-consistent sequence of steps leading to a desired result. These steps are those requiring physical manipulations of physical quantities. In the present invention, the operations referred to may be automated, machine operations done by a computer or similar device performed in conjunction with a human operator. The present invention relates to the methods for operating such devices, and processing electrical, magnetic, optic, or other physical signals to generate other desired physical signals. It further relates to a computer program and the control logic contained therein. The present invention also relates to apparatus for performing these operations. The apparatus may be specially constructed for the required purposes or it may comprise a general purpose computer selectively controlled or reconfigured by a computer program stored in the memory of the computer. Further, because the present invention is intended to include a network of participants, with no geographic limitations, it is contemplated that to better implement the system of the current invention, at least part of such implementation will take place on the Internet, or other computer network. The method presented herein is not inherently related to any particular computer or other apparatus. Similarly, no particular computer programming language is required. The required structure, although not machine specific, will be apparent from the description herein.

The present invention in its several disclosed embodiments alleviates the drawbacks described above by providing a method and system for streamlining the appointment process of healthcare providers. The method of the present invention comprises the steps of: a healthcare provider uploading a medical schedule onto a network communications system; and a patient accessing the medical schedule, selecting an available time for an appointment, inputting patient static and current information and securing the appoint with either an electronic payment or through a preauthorized insurance verification process. Preferably, the patient will submit an electronic payment to the healthcare provider, namely, but not limited to, the form of a credit card or direct withdrawal transaction. The patient then enters the healthcare provider's office on the scheduled day, the healthcare provider renders services to the patient, and the patient then leaves the healthcare provider's office.

In the context of this disclosure, the term “healthcare provider” will normally be used to indicate a healthcare provider or a member of a healthcare provider's staff such as nurses, medical assistants, employees, etc. The generic term “healthcare provider” is utilized because it is contemplated that the disclosed method and system may be used by any type of healthcare provider, for example and without limitation, physicians, chiropractors, dentists, psychiatrists, and therapists, or staff member in any practice area that employs the business custom of presetting appointments, including without limitation, dentistry, primary care, specialized medical practices, etc.

A healthcare provider may manipulate its appointment schedule, preferably before uploading the schedule onto the global network system, by blocking off unavailable times or allocating some time slots for longer appointment sessions. A preferred embodiment is for the schedule manipulation procedure to be conducted as a real-time transaction.

An advantage of the present invention is to encourage patient healthcare by reducing or even eliminating waiting time at the healthcare provider's office. The method and system of the present invention allow the patient to enter and update his/her static information, such as identification, address, contact, family history, personal history, insurance, and medications, as well as entering current information, such as chief complaint, symptoms, and history of present illness or condition, which allows the healthcare provider to become familiarized with a patient's medical problems before the actual appointment occurs. Thus, the healthcare provider is able to render quicker medical service to the patient. As a result, the present invention helps reduce idle time for both the healthcare provider and patient and allows a healthcare provider to adhere to a consistent schedule.

Further, the present invention helps the healthcare provider manage and maintain an organized schedule. The healthcare provider is capable of adjusting its schedule to block off unavailable times and designating time period allotments for appointments. The present invention allows for real-time appointment scheduling in order to avoid scheduling confusions such as double-booking and prioritizing.

Further, the present invention allows the healthcare provider the flexibility to operate his/her business on an electronic payment basis over the global network system. Through a global communications system, patients with minor healthcare needs have access to a healthcare provider's schedule and can secure an appointment through a preauthorized insurance verification procedure or with an electronic payment. As a result, these payment transactions allow the healthcare provider to reduce insurance claim paperwork and help healthcare providers to streamline their practice by increasing cash flow. The prepayment guarantees payment to the healthcare provider, who is therefore willing to not multiple-book patients' appointments for the same time period, which in turn reduces the patients' waiting time. Additionally, the prepayment provided incentive to patients to attend their appointments. Therefore, the present invention provides a new method and system for healthcare providers who want to simplify their practice and increase their revenue.

Further, the present invention is a method and system for practicing medicine that helps bring patients and healthcare providers together. Patients avoid having to wait in a crowded waiting room on the day of the appointment. The healthcare provider-patient interaction is enhanced where a patient can have a quality visit in as little as possible, and the general quality of life and business is improved.

Further, when patients travel, the present invention allows each patient to access a medical schedule of a healthcare provider in the particular area by imputing healthcare provider-related information such as zip code, state, city or the healthcare provider's name. The patient may then select an available time for an appointment, input patient information and secure the appointment through the insurance verification procedure or with an electronic payment. The present invention also makes the patient's static information available to remote healthcare providers.

Further, the administrator will allow linking from the database to individual healthcare provider sites on the network communications system. This allows patients, after having chosen a healthcare provider, to transfer directly from the system of the present invention to the chosen individual healthcare provider site. Thus, the healthcare provider can provide additional, selected information to the patient. Conversely, the link will also allow the patient who is viewing the individual healthcare provider site to access the functionality of the present invention, thus allowing the patient, after reviewing the healthcare provider's specific information, to immediately begin the appointment securing process.

Although this disclosure is couched in terms that anticipate the present invention being applied to healthcare services, it is further anticipated that the present invention could be applied to other service providers as well. The present invention would generally be utilized by providers that require appointments from their customers. Because the goal of the present invention is to streamline the appointment procedure, and to reduce waiting time for the customer in the office, the advantages of the present invention would be more apparent in a setting where such conditions exist. Without limitation, some examples of service providers that might employ the present invention with modifications of the input information and criteria, include: hair stylists, architects, attorneys, mechanics, repair shops, and advisers.

In order to solve the difficulties presented in attempting to obtain these features, a novel system has been developed for use on the internet, or other computer network. Numerous objects and advantages of the present invention will become apparent as the following detailed descriptions of the preferred embodiments are read in conjunction with the drawings which illustrate the same. The specific structures through which these benefits are delivered will be described in detail herein below.

### BRIEF DESCRIPTION OF THE DRAWINGS

FIG. 1. is a schematic of the present invention.

FIG. 2. is a flow chart of the present invention.

### DETAILED DESCRIPTION OF THE PREFERRED EMBODIMENT

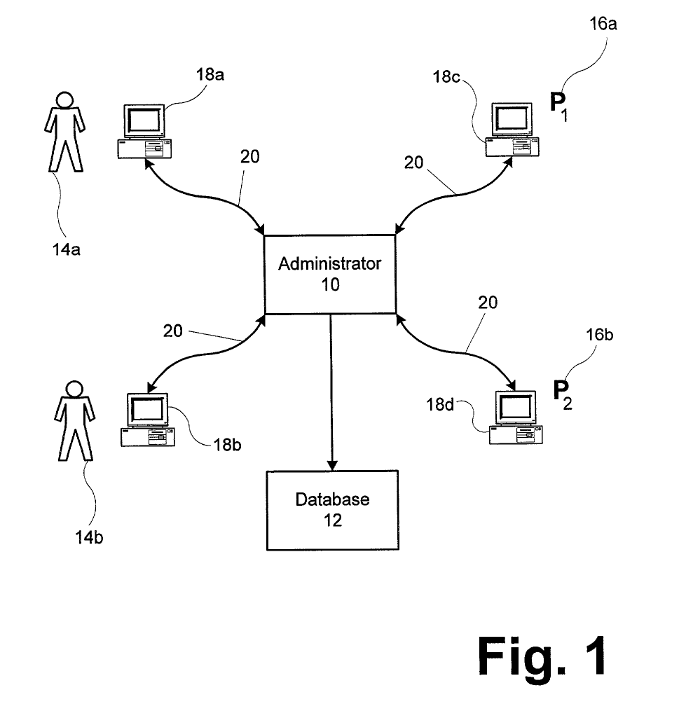

Referring to the figures, FIG. 1. illustrates the basic structure of the present invention. The present invention is a system and method for managing the scheduling of and payment for appointments, preferably geared toward patients (14) who either complain of minor health problems, or are scheduling routine or follow-up visits. It generally comprises the steps of: a healthcare provider (16) uploading an appointment schedule onto a database (12) via a network communications system (20) such as the Internet, or other computer, electronic, or communications network; and a patient (14) accessing the appointment schedule, selecting an available time period for an appointment, inputting patient static information and current information, and securing the appointment.

It is anticipated that the patient (14) may input his/her information using a data entry/display device (18). The system is comprised of multiple patients (14a and 14b) connected over a network communications system (20) via their data entry/display devices (18a and 18b) to the system administrator (10) who manages the system and maintains the database (12). This gives the first patient (18a) and the second patient (18b) access to the database (12). Likewise, multiple healthcare providers (16a and 16b) are connected over a network communications system (20) via their data entry/display devices (18c and 18d) to the system administrator (10) giving the first healthcare provider (16a) and the second healthcare provider (16b) access to the database (12). Thus, patients (14) are able to employ multiple healthcare providers (16), and healthcare providers (16) are able to service multiple patients (14) utilizing the centralized administrator (10) and database (12). The data entry/display devices (18a, 18b, 18c, and 18d) act as input means, and the administrator (10) will provide a recording means such as an appropriate computer algorithm, for inputting the healthcare provider's appointment schedule and the patient's static and current information into the database (12). Another computer algorithm acts as a process means to allow the patient to choose an appointment time period and secure the appointment time period with an electronic transaction. Because the system operates to secure appointments prior to the scheduled time period, and operates via the network communications system (20), information updates and appointment scheduling is in virtually real time.

The administrator (10) will be administering the system of the present invention for a network of multiple patients (14) and healthcare providers (16). In order to receive a fee for its services, the administrator (10) will facilitate the electronic transaction by running the transaction through the administrator as the hub of the network. This will allow the administrator (10) to split the patient's (14) payment, the administrator (10) taking a portion of the payment as a fee and forwarding the remainder of the payment to the healthcare provider (16).

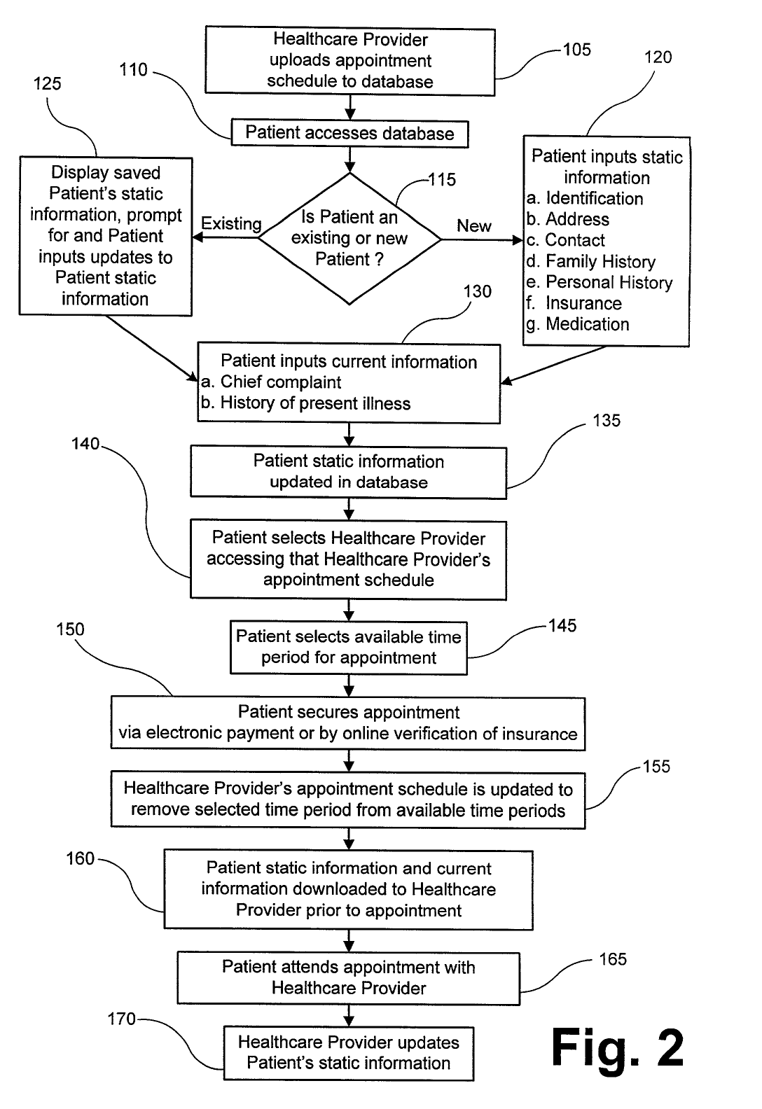

FIG. 2. illustrates the steps of the present invention. The healthcare provider may manipulate its appointment schedule before uploading its schedule (105) onto the database in order to designate available time periods for patient scheduled appointments. The patient accesses (110) the database, at which time it is determined (115) whether the patient is an existing or new patient.

If the patient is new, then the patient will be queried to input the patient's static information (120). The patient static information may include, but is not limited to: identification, address, contact, relevant family medical history, personal medical history, insurance, and medications. The patient's static information is saved on the administrator's database. Where it can be accessed by the patient for future appointments, to even further reduce the time of the system, as well as authorized healthcare providers. If the patient is an existing patient on the database, the patient's saved static information is displayed and the patient is prompted to update and correct the static information (125).

The patient inputs (130) its current information relevant to the reason for the appointment, for example without limitation, the patient's chief complaint and history of the present illness or condition. The patient's static information may be updated with the patient's current information (135) for future reference.

The patient selects a healthcare provider from the ones who have made their appointment schedules available on the database and the patient can then view the chosen healthcare provider's appointment schedule (140). The healthcare provider's schedule may include a textural display, a graphical display, a visual display, a video display or sound display. For patients who are traveling, the present invention allows each patient to access a health provider's appointment schedule in a particular area. Specifically, the patient will search for, and access, a healthcare provider's schedule by inputting healthcare provider-related information, such as zip code, state, city or the healthcare provider's name.

The patient can then select a desired appointment time period that the healthcare provider has available (145). The healthcare providers may choose to set their appointment schedules so that a standard time period (e.g. fifteen minutes) is allocated for each appointment. However, the healthcare provider may provide for longer, or shorter, appointments (e.g. forty-five minutes).

The patient secures (150) the appointment with an electronic transaction, anticipated to be an electronic payment, or through an electronic insurance verification process. In a preferred embodiment, payment is in the form of an electronic transaction such as a credit card or direct bank withdrawal transaction. Alternatively, the insurance verification process allows the patient to submit his/her insurance information to the healthcare provider. The healthcare provider will undergo an insurance verification procedure; and once the patient's insurance is approved, the patient's appointment is secured. Once the appointment is secured, the healthcare provider's appointment schedule on the database is updated to remove the chosen time period from the available time periods (155). In a preferred embodiment, a notification may be sent from the healthcare provider to the patient confirming the scheduled appointment. This notification may be immediately sent to the patient, or alternatively, sent closer to the date of the scheduled appointment.

At any time before the scheduled appointment, the patient's previously entered static and current information is downloaded to the healthcare provider (160), who is able to review the information and contemplate possible diagnoses even before the patient's appointment occurs. When the patient enters (165) the healthcare provider's office, the healthcare provider, acting upon the alleged symptoms, will render appropriate medical services, such as a physical examination, on the patient. The healthcare provider may, during the appointment, ask the patient further medical-related questions in order to render an objective diagnosis. Once the healthcare provider has reached a professional conclusion, he/she may write the patient a prescription, if needed. In a preferred embodiment, the healthcare provider's visit should be conducted in designated time period. After the medical appointment has been rendered, the patient exits the healthcare provider's office and the healthcare provider can update the patient's static or current information (170) for inclusion on the database. If any follow-up or later visits are necessary, the patient may schedule a subsequent appointment via the present invention.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. A method for securing an appointment with a healthcare provider comprising the steps of:
said healthcare provider uploading an appointment schedule onto a database via a network communications system;
a patient inputting said patient's static information and said patient's current information onto said database via said network communications system;
said patient accessing said appointment schedule;
said patient selecting an available time period on said appointment schedule for an appointment; and
said patient securing said appointment with an electronic transaction.

2. A system for securing an appointment with a healthcare provider, said system comprising:
a database for storing said healthcare provider's appointment schedule and a patient's static information and current information;
an input means for receiving said healthcare provider's appointment schedule and said patient's static information and current information;
a recording means for storing said healthcare provider's appointment schedule and said patient's static information and current information in said database;
a process means for said patient securing an appointment during a time period, said process means carry out the operations of:
a) displaying said healthcare provider's appointment schedule to said patient;
b) allowing said patient to designate said time period;
c) facilitating an electronic transaction on behalf of said patient to provide for payment for said appointment; and
d) updating said healthcare provider's appointment schedule such that said time period is no longer listed as available.

3. A method in a computer system for securing an appointment with a healthcare provider, the method comprising:
receiving said healthcare provider's appointment schedule;
storing said healthcare provider's appointment schedule in a database;
receiving a patient's static information and said patient's current information;
storing said patient's static information and said patient's current information in said database;
processing said patient's choice of an appointment time period;
facilitating an electronic transaction by said patient to secure said appointment; and
updating said healthcare provider's appointment schedule.

4. In article of manufacture comprising:
A computer useable medium have computer readable program code means embodied therein for controlling a system for securing an appointment with a healthcare provider, said computer readable program code means in said article of manufacture comprising:
computer readable program code means for causing receiving a patient's static information and said patient's current information;
computer readable program code means for causing storing said patient's static information and said patient's current information in said database;
computer readable program code means for causing processing said patient's choice of an appointment time period;
computer readable program code means for facilitating an electronic transaction by said patient to secure said appointment; and
computer readable program code means for updating said healthcare provider's appointment schedule.

5. A method of facilitating securing an appointment with a healthcare provider over a computer network comprising the steps of:
receiving said healthcare provider's appointment schedule;
storing said healthcare provider's appointment schedule in a database;
receiving a patient's static information and said patient's current information;
storing said patient's static information and said patient's current information in said database;
processing said patient's choice of an appointment time period;
facilitating an electronic transaction by said patient to secure said appointment; and
updating said healthcare provider's appointment schedule.
